(19) United States
(12) Patent Application Publication
(10) Pub. No.: US 2024/0163146 A1
(43) Pub. Date: May 16, 2024

(54) MULTI-MODE WIRELESS TRANSMISSION METHOD AND APPARATUS

(71) Applicant: Electronics and Telecommunications Research Institute, Daejeon (KR)

(72) Inventors: Il Gu LEE, Gwangmyeong (KR); Hee Soo LEE, Daejeon (KR); Sok Kyu LEE, Daejeon (KR)

(21) Appl. No.: 18/393,415

(22) Filed: Dec. 21, 2023

Related U.S. Application Data
(63) Continuation of application No. 16/905,708, filed on Jun. 18, 2020.
Application No. 16/905,708 is a continuation of application No. 14/525,047, filed on Oct. 27, 2014, now abandoned.

(30) Foreign Application Priority Data
Oct. 28, 2013 (KR) 10-2013-0128672
Jan. 14, 2014 (KR) 10-2014-0004562

(51) Int. Cl. H04L 27/20; H04L 5/00; H04L 27/00

(52) U.S. Cl. CPC H04L 27/206; H04L 5/0053; H04L 27/0008

(57) ABSTRACT

Provided is a next-generation wireless local area network (WLAN) frame communication method. The communication method may include modulating a first symbol in a signal field A (SIG-A) of a next-generation WLAN frame using a first modulation method, modulating a second symbol in the SIG-A of the next-generation WLAN frame using a second modulation method, and modulating a short training field (STF) signal of the next-generation WLAN frame in response to a next-generation WLAN mode.

### CROSS-REFERENCE TO RELATED APPLICATION

This application is a continuation application of U.S. application Ser. No. 16/905,708 filed on Jun. 18, 2020, which is a continuation application of U.S. application Ser. No. 14/525,047, filed on Oct. 27, 2014, and claims the priority benefit of Korean Patent Application No. 10-2013-0128672, filed on Oct. 28, 2013, and Korean Patent Application No 10-2014-0004562, filed on Jan. 14, 2014, in the Korean Intellectual Property Office, the disclosures of which are incorporated herein by reference. The foreign priority documents have been retrieved in U.S. application Ser. No. 14/525,047.

### BACKGROUND

### 1. Field of the Invention

The present invention relates to wireless communication technology, and more particularly, to a multi-mode wireless communication transmission method and apparatus.

### 2. Description of the Related Art

Recently, various wireless communication technologies have been developed in conjunction with development of information and communication technology. Among the wireless communication technologies, a wireless local area network (WLAN) may allow users to wirelessly access the Internet at home, a workplace, or a service area using a portable terminal, for example, a personal digital assistant (PDA), a laptop computer, and a portable multimedia player (PMP), based on radio frequency (RF) technology. Since February in 1980 when the Institute of Electrical and Electronics Engineers (IEEE) 802, which is an organization for standardization of WLAN technology, was established, numerous standardization tasks have been conducted.

A wireless communication system has also been developed to transmit a large quantity of data at a high speed. Types of the wireless communication system may include, for example, a wireless broadband (WiBro) communication system, a third generation partnership project (3GPP) long term evolution (LTE) system, and a very high throughput (VHT) system of the WLAN. Accordingly, there is a desire for a transmission method for providing high efficiency and high performance while maintaining compatibility with an existing IEEE 802.11a/n/ac to transmit a next-generation WLAN frame, which is an next-generation WLAN standard.

### SUMMARY

According to an aspect of the present invention, there is provided a next-generation wireless local area network (WLAN) frame communication method, the communication method including modulating a first symbol in a signal field A (SIG-A) of a next-generation WLAN frame using a first modulation method, modulating a second symbol in the SIG-A of the next-generation WLAN frame using a second modulation method, and modulating a short training field (STF) signal of the next-generation WLAN in response to a next-generation WLAN mode.

In an example, the modulating of the first symbol may include modulating the first symbol in the SIG-A of the next-generation WLAN frame using binary phase-shift keying (BPSK). The modulating of the second symbol may include modulating the second symbol in the SIG-A of the next-generation WLAN frame using quadrature BPSK (Q-BPSK). The modulating of the STF signal may include modulating the STF signal of the next-generation WLAN frame to have a phase difference of 90 degrees (°) from a very high throughput (VHT)-STF signal.

In another example, the modulating of the first symbol may include modulating the first symbol in the SIG-A of the next-generation WLAN frame using BPSK. The modulating of the second symbol may include modulating the second symbol in the SIG-A of the next-generation WLAN frame using the BPSK. The modulating of the STF signal may include modulating the STF signal of the next-generation WLAN frame using Q-BPSK.

In still another example, a BPSK signal may be mapped to signal coordinates of (−1, 1) and (1, −1).

According to another aspect of the present invention, there is provided a next-generation WLAN frame communication method including receiving a communication signal, verifying a first symbol and a second symbol in an SIG-A of the communication signal, verifying an STF signal of the communication signal when the first symbol is a BPSK signal and the second symbol is a Q-BPSK signal, and identifying a communication mode of a next-generation WLAN frame based on the STF signal.

The identifying may include determining the communication mode to be a next-generation WLAN mode when the STF signal has a phase difference of 900 from a VHT-STF signal.

According to still another aspect of the present invention, there is provided a next-generation WLAN frame communication method including receiving a communication signal, verifying a first symbol and a second symbol in an SIG-A of the communication signal, verifying an STF signal of the communication signal when the first symbol is a BPSK signal and the second symbol is a BPSK signal, and identifying a communication mode of a next-generation WLAN frame based on the STF signal.

The identifying may include determining the communication mode to be a next-generation WLAN mode when the STF signal is a Q-BPSK signal.

According to yet another aspect of the present invention, there is provided a next-generation WLAN frame communication method including modulating a first symbol in an SIG-A of a next-generation WLAN frame using a first modulation method, modulating a second symbol in the SIG-A of the next-generation WLAN frame using a second modulation method, and modulating a third symbol in the SIG-A of the next-generation WLAN frame in response to a next-generation WLAN mode.

In an example, the modulating of the first symbol may include modulating the first symbol in the SIG-A of the next-generation WLAN frame using BPSK. The modulating of the second symbol may include modulating the second symbol in the SIG-A of the next-generation WLAN frame using Q-BPSK. The modulating of the third symbol may include modulating the third symbol in the SIG-A of the next-generation WLAN frame to have a phase difference of 90° from a VHT-STF signal.

In another example, the modulating of the first symbol may include modulating the first symbol in the SIG-A of the next-generation WLAN frame using BPSK. The modulating of the second symbol may include modulating the second symbol in the SIG-A of the next-generation WLAN frame using the BPSK. The modulating of the third symbol may include modulating the third symbol in the SIG-A of the next-generation WLAN frame using Q-BPSK.

According to a further aspect of the present invention, there is provided an next-generation WLAN frame communication method including receiving a communication signal, verifying a first symbol and a second symbol in an SIG-A of the communication signal, verifying a third symbol in the SIG-A when the first symbol is a BPSK signal and the second symbol is a Q-BPSK signal, and identifying a communication mode of a next-generation WLAN frame based on the third symbol.

The identifying may include determining the communication mode to be a next-generation WLAN mode when the third symbol has a phase difference of 90° from a VHT-STF signal.

According to still another aspect of the present invention, there is provided a next-generation WLAN frame communication method including receiving a communication signal, verifying a first symbol and a second symbol in an SIG-A of the communication signal, verifying a third symbol in the SIG-A when the first symbol is a BPSK signal and the second symbol is a BPSK signal, and identifying a communication mode of a next-generation WLAN frame based on the third symbol.

The identifying may include determining the communication mode to be a next-generation WLAN mode when the third symbol is a Q-BPSK signal.

According to still another aspect of the present invention, there is provided a next-generation WLAN frame communication method including generating a signal field (SIG) of a next-generation WLAN frame to have a length equal to an SIG of a VHT frame, and inputting, as a first value, a predetermined reserved bit among reserved bits in a structure of the SIG of the VHT frame.

The next-generation WLAN frame communication method may further include modulating a first symbol in an SIG-A of the next-generation WLAN frame using BPSK, and modulating a second symbol in the SIG-A of the next-generation WLAN frame using Q-BPSK.

The inputting may include inputting, as the first value, the predetermined reserved bit in a next-generation WLAN mode, and inputting, as a second value, the predetermined reserved bit in a VHT mode.

According to still another aspect of the present invention, there is provided a next-generation WLAN frame communication method including receiving a WLAN frame, verifying a predetermined reserved bit among reserved bits in a structure of an SIG of a VHT frame of the WLAN frame, and identifying a communication mode of the WLAN frame based on the identified reserved bit.

The identifying may include determining the communication mode to be a next-generation WLAN mode when the identified reserved bit is a first value, and determining the communication mode to be a VHT mode when the identified reserved bit is a second value.

According to still another aspect of the present invention, there is provided a next-generation WLAN frame communication method including generating an SIG of a next-generation WLAN frame to have a length equal to an SIG of a high throughput (HT) frame, and inputting, as a first value, a reserved bit in a structure of the SIG of the HT frame in a next-generation WLAN mode.

According to still another aspect of the present invention, there is provided a next-generation WLAN frame communication method including receiving a WLAN frame, verifying a reserved bit among reserved bits in a structure of an SIG of an HT frame of the WLAN frame, and identifying a communication mode of the WLAN frame based on the identified reserved bit.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an example of a configuration of a conventional wireless local area network (WLAN) frame;

FIG. 2 is a diagram illustrating an example of a configuration of a next-generation WLAN frame according to an embodiment of the present invention;

FIG. 3 is a diagram illustrating an example of a conventional WLAN frame transmitting method;

FIG. 4 is a diagram illustrating an example of a next-generation WLAN frame transmitting method according to an embodiment of the present invention;

FIG. 5 is a diagram illustrating another example of a next-generation WLAN frame transmitting method according to an embodiment of the present invention;

FIGS. 6A and 6B are diagrams illustrating examples of a method of transmitting frame type information included in a signal field (SIG) according to an embodiment of the present invention;

FIGS. 7A through 7C are diagrams illustrating examples of a very high throughput (VHT) frame detecting method according to an embodiment of the present invention;

FIG. 8 is a diagram illustrating a still another example of a next-generation WLAN frame transmitting method according to an embodiment of the present invention;

FIGS. 9A and 9B are diagrams illustrating examples of a high throughput (HT) frame detecting method according to an embodiment of the present invention;

FIGS. 10 through 21 are flowcharts illustrating examples of a next-generation WLAN frame communication method according to embodiments of the present invention;

FIG. 22 is a diagram illustrating an example of a structure of an Institute of Electrical and Electronics Engineers (IEEE) 802.11 physical layer; and

FIG. 23 is a diagram illustrating an example of a configuration of a next-generation WLAN frame communication apparatus according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the accompanying drawings, however, the present invention is not limited thereto or restricted thereby.

When it is determined a detailed description related to a related known function or configuration that may make the purpose of the present invention unnecessarily ambiguous in describing the present invention, the detailed description will be omitted here. Also, terms used herein are defined to appropriately describe the exemplary embodiments of the present invention and thus may be changed depending on a user, the intent of an operator, or a custom. Accordingly, the terms must be defined based on the following overall description of this specification.

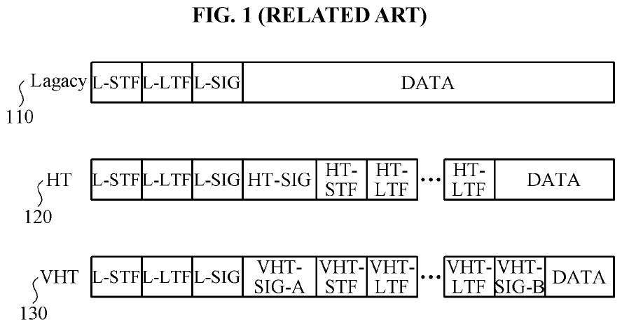

FIG. 1 is a diagram illustrating an example of a configuration of a conventional wireless local area network (WLAN) frame.

Referring to FIG. 1, a conventional WLAN may include a legacy standard 11a/b/g and a high throughput (HT) standard 11n in an Institute of Electrical and Electronics Engineers (IEEE) 802.11 group, and a very high throughput (VHT). A configuration of a WLAN physical layer convergence protocol (PLCP) protocol data unit (PPDU) may be indicated as in FIG. 1.

The WLAN may support a transmission method of a legacy, an HT, and a VHT mode. The IEEE 802.11a/g may be classified as a legacy type, the IEEE 802.11n as the HT mode, and the IEEE 802.11ac as the VHT mode.

A WLAN system may transmit a PPDU by including, in a header field, signal information used for a receiving end to correctly restore the PPDU. The signal information may be vital to restore PPDU data and thus, may be transmitted using a lowest modulation and coding scheme (MCS) to be robust against channel variation and noise. As illustrated in FIG. 1, a legacy PPDU 110 may be classified into a legacy short training field (L-STF), a legacy long training field (L-LTF), a legacy signal field (L-SIG), and a data field (DATA). An HT PPDU 120 may be classified into an L-STF, an L-LTF, an L-SIG, an HT-SIG, an HT-STF, an HT-LTF, and a DATA. A VHT PPDU 130 may be classified into an L-STF, an L-LTF, an L-SIG, a VHT signal field A (VHT-SIG-A), a VHT-STF, a VHT-LTF, a VHT signal field B (VHT-SIG-B), and a DATA.

The L-STF may be used for carrier sensing to detect whether a signal is present in a currently used channel, automatic gain control to match a radio signal to be input to an antenna with an operation range of an analog circuit and an analog-to-digital converter (ADC), and coarse carrier frequency offset correction.

The L-LTF may be used for fine carrier frequency offset correction, symbol synchronization, and channel response estimation to demodulate the L-SIG, and the HT-SIG or the VHT-SIG. In addition, the L-LTF may be used to estimate a signal-to-noise ratio (SNR) by applying a principle of two symbols alternately repeating therewith.

Using iterative sequences such as the L-STF and the L-LTF may enable an estimation of various characteristics of a channel, for example, interference, Doppler shift, and delay spread.

Signal fields (SIGs) such as the L-SIG, the HT-SIG, and the VHT-SIG may include control information required to demodulate PPDU received by a terminal or an access point (AP). For example, the control information may include a packet length, MCS, a bandwidth and channel encoding method, beamforming, space-time block coding (STBC), a smoothing method, multiuser multiple-input and multiple-output (MU-MIMO), a short guard interval (SGI) mode. The VHT-SIG may be classified into the VHT-SIG-A for shared control information and the VHT-SIG-B for information dedicated to a multiuser (MU) group, and then transmitted. In addition, the control information may further include identification (ID) information such as a group ID and a partial association ID (PAID).

The L-SIG, the HT-SIG, and the VHT-SIG may be used to provide information on a type of a frame. The L-SIG, the HT-SIG, and the VHT-SIG may transmit a transmission symbol using binary phase shift keying (BPSK) or quadrature BPSK (Q-BPSK) to provide information as to which type of a frame a terminal receives. A Q-BPSK signal may be obtained by rotating a phase of a BPSK signal by 90°. Thus, the Q-BPSK may ensure a maximum orthogonality in comparison to the BPSK.

In a case of a 802.11n frame, the 802.11n frame may be recognized by transmitting two HT-SIG symbols using the Q-BPSK and detecting the two symbols whose phases are rotated by 90° from the BPSK of a legacy frame. Here, to transmit the 802.11n frame, a rate of the L-SIG may be set to 6 mega bit per second (Mbps), and a length may be described as a period of time during which the frame occupies a channel. Thus, when the rate is determined to be 6 Mbps, determination on which one of the BPSK and the Q-BPSK is used for detection of an HT frame may be performed.

In a case of a 802.11ac frame, a first symbol of the VHT-SIG is required to be transmitted using the BPSK and a second symbol of the VHT-SIG is required to be transmitted using the Q-BPSK. Since the first symbol is transmitted using the BPSK, an 11n device may recognize the frame as a legacy frame, and an 11ac device may recognize the frame as a VHT frame by recognizing the Q-BPSK with respect to the second symbol.

The HT-STF or the VHT-STF may be used to increase a gain control performance of an automatic gain control (AGC), and additional gain control may be required for using beamforming technology.

The HT-LTF or the VHT-LTF may be used for the terminal or the AP to estimate a channel. Dissimilar to the legacy standard, by the 802.11n or the 802.11ac standard, a throughput may be improved by increasing the number of carriers to be used, and a new LTF may be defined to restore data in addition to the L-LTF. The VHT-LTF may include a pilot signal for offset correction.

The DATA may include data information to be transmitted. The DATA may convert a media access control (MAC) layer PDU (MPDU) to a physical layer service data unit (PSDU), and include a service field and a tail bit to perform transmission.

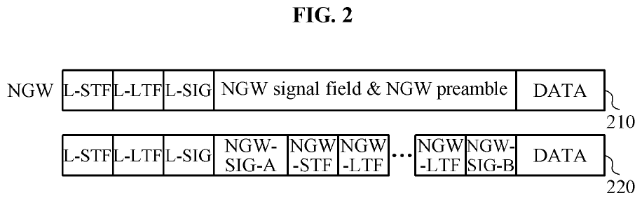

FIG. 2 is diagram illustrating an example of a configuration of a next-generation WLAN frame according to an embodiment of the present invention.

Referring to FIG. 2, an example of configuration of a next-generation WLAN frame (hereinafter also referred to as an NGW frame), which is a next-generation WLAN transmission standard, is illustrated as 210. The NGW frame may include an L-STF, an L-LTF, and an L-SIG to maintain backward compatibility with a conventional WLAN standard transmission method, and include an NGW signal field (SIG) and an NGW preamble to transmit signaling information used to restore NGW data. Subsequent to the NGW-SIG and the NGW preamble, data information (DATA) having a variable length may be included.

The DATA of the NGW frame may include a data tone and a pilot tone. Using a travelling pilot may enable a change in a transmission position of the pilot for each symbol and maintenance of a performance robust against a Doppler shift. Alternatively, a midamble in an NGW-LTF structure may be periodically included between data symbols. Using the midamble may enable a wireless terminal to more quickly adapt to a channel variation and a phase shift and thereby, improving a performance outdoors. In addition, since a guard interval length of the DATA is variable, the guard interval length may be variably adjusted by an indicator of the SIG based on a channel environment to achieve robustness against delay spread.

Referring to FIG. 2, another example of a configuration of an NGW frame is illustrated as 220. As illustrated in 220, the NGW frame may include an L-STF, an L-LTF, and an L-SIG, and subsequently, an NGW-SIG-A, an NGW-STF, an NGW-LTF, an NGW-SIG-B, and DATA.

The NGW-SIG-A may provide a single user with information on a packet length that may decode a packet, MCS, a bandwidth and channel encoding method, beamforming, STBC, smoothing, MU-MIMO, an SGI mode, a delay spread state, a channel quality, a group ID, a PAID, and the like.

The NGW-STF may enable fine gain control when applying a beamforming transmission method or a multiple antenna transmission method. The NGW-LTF may be used for channel estimation and phase correction, or phase tracking, to restore an NGW data frame.

The DATA may include a data value transmitted through a method suitable for the signal information. The DATA may include a periodic pilot sequence as a reference signal to track and correct a phase, a signal magnitude, a residual frequency offset, and the like in order to restore data transmitted based on information described in the SIG. The pilot sequence may operate in a traveling pilot mode or a fixed pilot mode depending on pilot sequence mode information described in the SIG. The fixed pilot mode may refer to a mode in which a position of a pilot is fixed and the pilot is present in an identical position for each symbol per datum, whereas the travelling pilot mode may refer to a mode in which a position of a pilot is periodically rotated for each symbol and the position of the pilot is restored to an original position after a predetermined number of symbols. Using the travelling pilot may enable overcoming of the channel variation by which a channel state is significantly changed due to the Doppler shift or the delay spread.

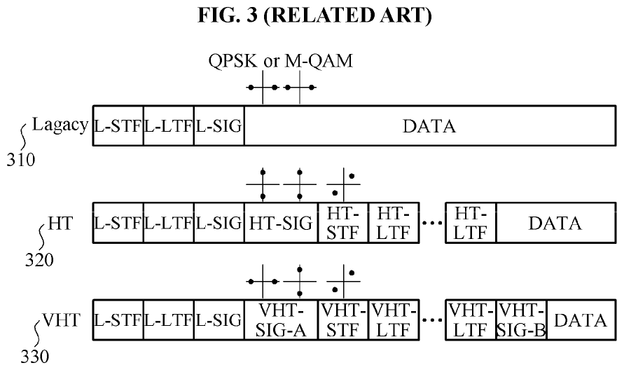

FIG. 3 is a diagram illustrating an example of a conventional WLAN frame transmitting method.

Referring to FIG. 3, a legacy frame 310 transmitting method may be performed using a quadrature phase-shirt keying (QPSK) modulation method for a first symbol and a second symbol in an SIG.

An HT frame 320 transmitting method may be performed using a Q-BPSK modulation method for a first symbol and a second symbol in an SIG.

A VHT frame 330 transmitting method may be performed using a BPSK modulation method for a first symbol in an SIG and using the Q-BPSK modulation method for a second symbol in the SIG.

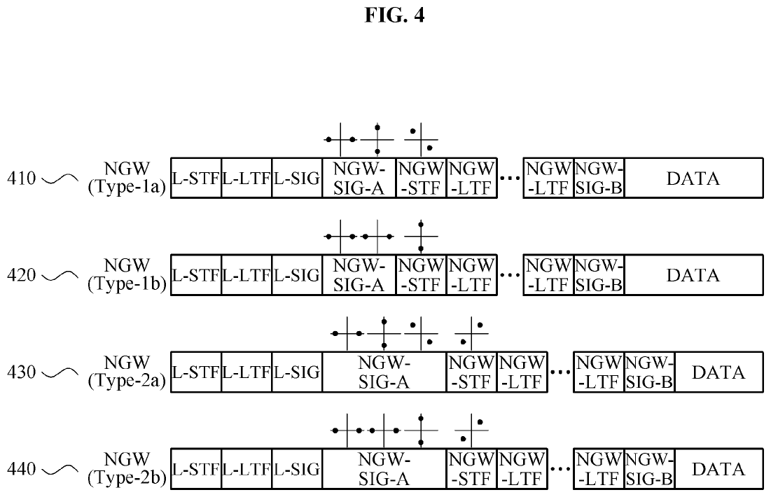

FIG. 4 is a diagram illustrating an example of an NGW frame transmitting method according to an embodiment of the present invention.

Referring to FIG. 4, in a case of an NGW (Type-1a) frame 410 transmitting method, a first symbol in an NGW-SIG-A may be modulated using BPSK, and a second symbol in the NGW-SIG-A may be modulated using Q-BPSK. As illustrated in FIG. 3, an identical modulation method applied to a VHT-SIG-A may be used to allow information in the NGW-SIG-A to be compatible with a VHT device and enable spoofing and power save for the VHT device. The spoofing may refer to a function of recognizing that terminals using a conventional standard receive a conventional frame and preventing the terminals from accessing a channel for a period of time to be calculated based on rate and length information described in the SIG. The power save may refer to a function of discontinuing a subsequent processing and entering a power save mode when a frame is not the one that a terminal is to receive based on ID information in the SIG. When an NGW (Type-1a) frame 410 is received, a receiving end may determine a packet type based on transmission performed using the BPSK to rotate NGW-STF signal coordinates by 1350 counterclockwise from an X axis and allow an NGW-STF signal to have a phase difference of 90° from an existing VHT-STF signal. In a case of the VHT-STF signal, a BPSK signal may be mapped to signal coordinates of (1,1) and (−1, −1). However, in a case of the NGW-STF signal, a BPSK signal may be mapped to signal coordinates of (−1,1) and (1,−1). Thus, the two signals may have the phase difference of 90°. In the SIG prior to the VHT-STF or the NGW-STF, the frame may be recognized as a VHT or an NGW frame based on the BPSK signal and a Q-BPSK signal, and a frame mode may be recognized by recognizing a phase of a subsequent STF signal. A VHT device may perform the spoofing based on signal field information recognized as the L-SIG and the VHT-SIG-A, and an NGW device may simultaneously perform detection of a frame type and automatic gain control in the NGW-STF.

Referring to FIG. 4, in a case of an NGW (Type-1b) frame 420 transmitting method, both two symbols in an NGW-SIG-A may be transmitted using the BPSK modulation method, and the NGW-STF may be transmitted using the Q-BPSK. Thus, the frame may be distinguishable from a legacy frame format. When the two symbols subsequent to the L-SIG are transmitted using the BPSK, a legacy terminal, an HT terminal, and a VHT terminal may recognize the frame as a legacy frame. However, an NGW terminal may determine whether the frame is the legacy frame or the NGW frame by distinguishing between the BPSK and the Q-BPSK at a position of the NGW-STF, and determine a packet type. In a case of the NGW frame, an NGW-STF may be transmitted using the Q-BPSK. Conversely, in a case of the legacy frame, the NGW-STF may be transmitted as a BPSK signal. Thus, a frame mode may be determined based on the phase difference of 900 of the signal. In the case of the NGW frame, transmission may be performed at a set rate of 6 Mbps and thus, only the BPSK signal may need to be considered in the case of the legacy frame.

An NGW (Type 2) frame transmitting method may be performed by including more sets of signal field information than an NGW (Type 1) frame transmitting method by transmitting a symbol in an NGW-SIG-A to be three symbol lengths.

Referring to FIG. 4, in a case of an NGW (Type-2a) frame 430 transmitting method, a first symbol in an NGW-SIG-A may be transmitted using the BPSK and a second symbol in the NGW-SIG-A may be transmitted using the Q-BPSK and thus, both a VHT terminal and an NGW terminal may use a corresponding SIG. A third symbol may be transmitted by performing phase rotation at 1350 counterclockwise from an X axis and thus, whether a VHT frame or an NGW frame may be determined. The third symbol in the NGW-SIG-A of the NGW frame may have a phase difference of 90° from a VHT-STF signal of the VHT frame and thus, whether a received frame is the VHT frame or the NGW frame may be determined. In the NGW (Type-2a) frame 430 transmitting method, the NGW-STF may be transmitted using the BPSK through which a phase of an NGW-STF signal is rotated by 450 counterclockwise from an X axis. In such a transmitting method, a 802.11a/n device may recognize a received packet as a legacy frame, a 802.11ac device may recognize a received packet as a 802.11ac packet, and a 802.11ax (high efficiency WLAN (HEW)) device may recognize, as a 802.11ax packet, a packet received based on a BPSK signal obtained by 135° phase rotation.

Referring to FIG. 4, in a case of an NGW (Type-2b) frame 440 transmitting method, a first symbol and a second symbol in an NGW-SIG-A may be transmitted using the BPSK, and a third symbol may be transmitted using the Q-BPSK. Thus, whether the frame is a legacy frame or an NGW frame may be determined. Since the first and the second symbols in the NGW-SIG-A are transmitted using the BPSK, a legacy terminal, an HT terminal, and a VHT terminal may recognize the frame as a legacy frame and thus, the spoofing may be performed based on rate and length information in the SIG. In contrast, an NGW terminal may determine the frame to be the NGW frame by detecting that the first and the second symbols are BPSK signals and a third symbol is a Q-BPSK signal. When a rate is 6 Mpbs, the NGW terminal determines whether the frame is the legacy frame or the NGW frame, only whether the BPSK or the Q-BPSK is used at a position of the third symbol in the NGW-SIG-A may need to be determined. In the NGW (Type-2b) frame 440 transmitting method, the NGW-STF may be transmitted using the BPSK through which a phase of an NGW-STF signal is rotated by 450 counterclockwise from an X axis. In such a transmitting method, a 802.11a/n/ac device may recognize a received packet as the legacy frame, and a 802.11ax device may detect the Q-BPSK with respect to the third symbol and determine a corresponding packet to be a 802.11ax frame.

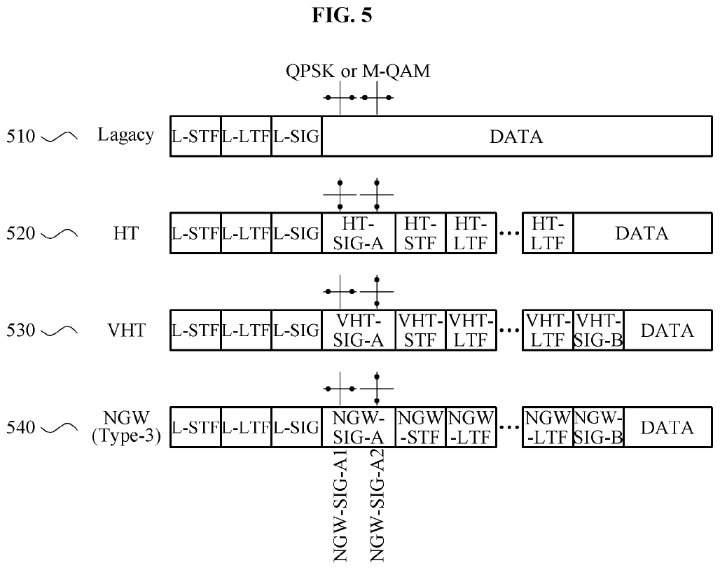

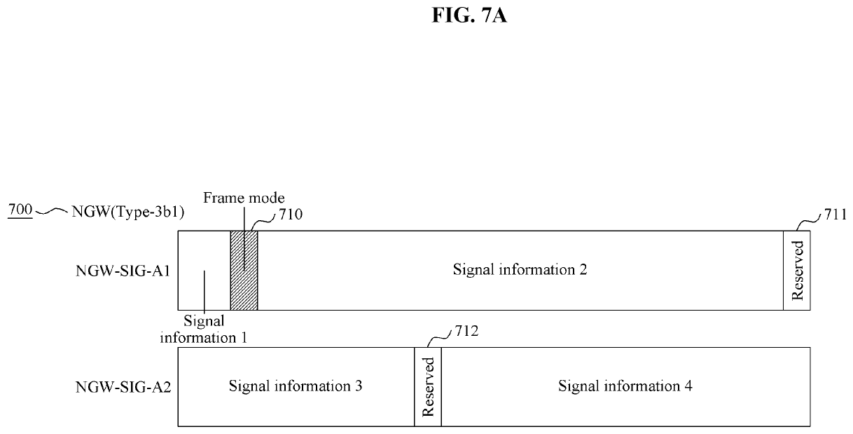

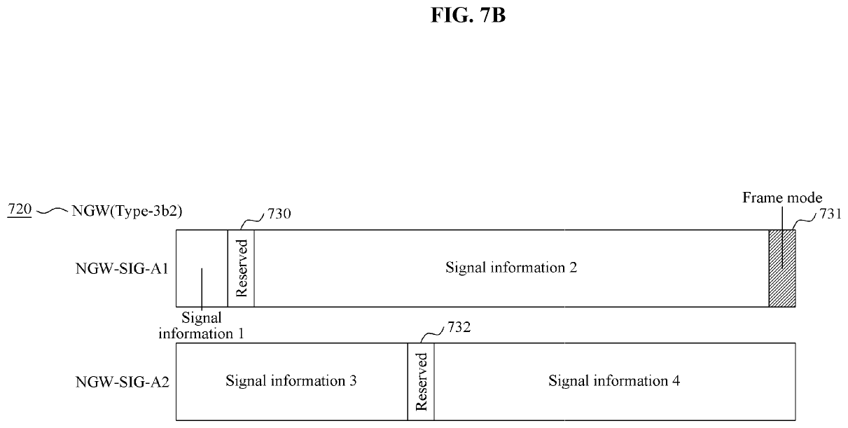

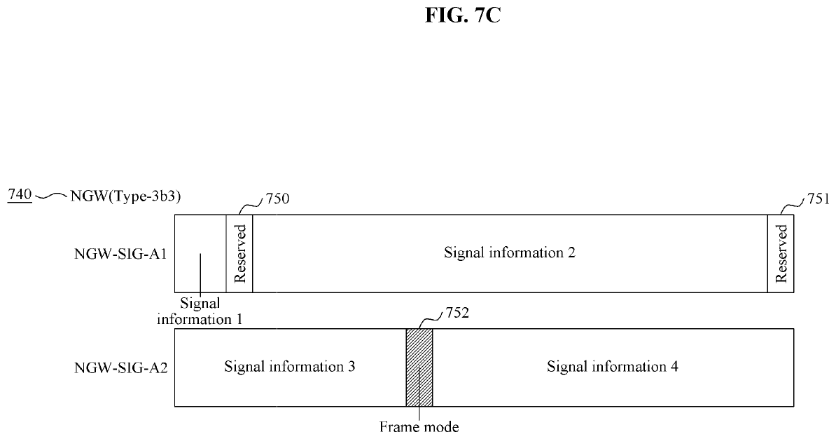

According to an embodiment, a next-generation WLAN frame communication method may include determining a type of a frame by modulating and transmitting a symbol. In the next-generation WLAN frame communication method, a description of a method of transmitting frame type information included in an SIG will be provided with reference to FIGS. 5 and 7.

FIG. 5 is a diagram illustrating another example of an NGW frame transmitting method according to an embodiment of the present invention.

FIG. 5 illustrates a method of transmitting frame type information included in an SIG. A modulation method applied to the SIG may be maintained identically to a VHT mode frame, but allow an NGW device to recognize an NGW frame mode using a reserved bit.

As described with reference to FIG. 3, a legacy frame 510 transmitting method may be performed using a QPSK modulation method for a first symbol and a second symbol in the SIG. An HT frame 520 transmitting method may be performed using a Q-BPSK modulation method for a first symbol and a second symbol in the SIG. A VHT frame 530 transmitting method may be performed using a BPSK for a first symbol in the SIG and using the Q-BPSK for a second symbol in the SIG.

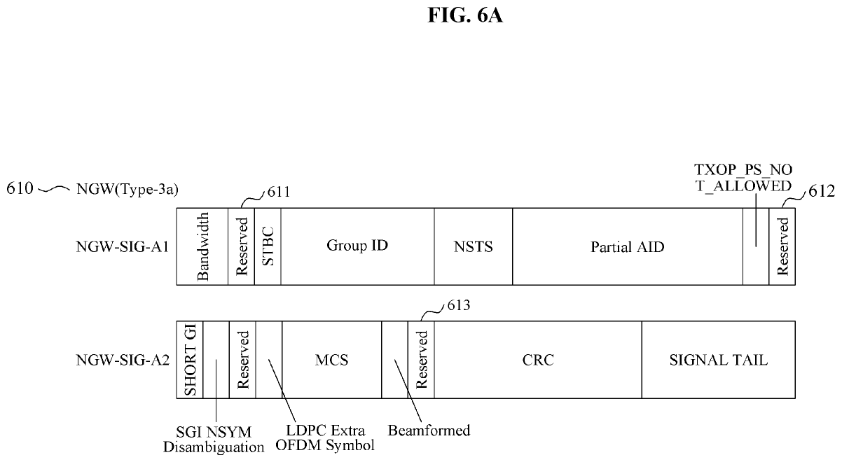

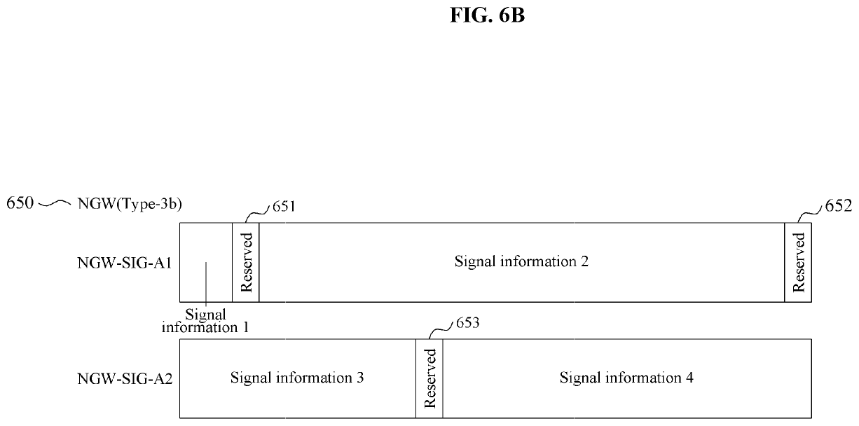

As provided in the foregoing description of the VHT frame 530 transmitting method, an NGW (Type-3) frame 540 transmitting method may maintain the modulation method to be identical to the VHT mode frame. However, the NGW (Type-3) frame 540 and the VHT frame 530 may be distinguished using a reserved bit. A method of distinguishing between the VHT mode and the NGW mode will be described in detail with reference to FIGS. 6A and 6B and 7A through 7C.

FIGS. 6A and 6B are diagrams illustrating examples of a method of transmitting frame type information included in an SIG according to an embodiment of the present invention.

FIG. 6A illustrates an example of an NGW (Type-3a) frame 610 transmitting method. An NGW frame of the NGW (Type-3a) frame 610 may have a configuration of an SIG identical to a VHT frame format. A VHT frame may have three reserved bits 611, 612, and 613, among which at least one reserved bit may be used to distinguish between an NGW mode and a VHT mode. Accordingly, the frame format information may be defined using a value of the at least one of the three reserved bits 611, 612, and 613. For example, when a value of a reserved bit is “0,” the frame format information may be defined as the NGW mode. When the value of the reserved bit is “1,” the frame format information may be defined as the VHT mode. Alternatively, when the value of the reserved bit is “1,” the frame format information may be defined as the NGW mode. When the value of the reserved bit is “0,” the frame format information may be defined as the VHT mode.

The NGW (Type-3a) frame 610 transmitting method may be performed by modulating a first symbol in an NGW-SIG-A using BPSK and modulating a second symbol in the NGW-SIG-A using Q-BPSK. Thus, a legacy terminal and an HT terminal may be recognized as a legacy mode, and a VHT terminal may be recognized as the VHT mode. An NGW terminal may determine the NGW mode using the reserved bit.

FIG. 6B illustrates an example of an NGW (Type-3b) frame 650 transmitting method. The NGW (Type-3b) frame 650 may be a frame format newly defining other sets of signal information, for example, signal information 1, signal information 2, signal information 3, and signal information 4, excluding positions of reserved bits 651, 652, and 653. As in a case of the NGW (Type-3a) frame 610, an apparatus receiving the NGW (Type-3b) frame 650 may classify a frame mode using a value of at least one of the reserved bits 651, 652, and 653. For example, when the reserved bit is “0,” the frame mode may be classified as an NGW mode. When the reserved bit is “1,” the frame mode may be classified as a VHT mode. Alternatively, when the reserved bit is “1,” the frame mode may be classified as the NGW mode. When the reserved bit is “0,” the frame mode may be classified as the VHT mode.

The NGW (Type-3b) frame 650 transmitting method may be performed using BPSK for a first symbol in an NGW-SIG-A, and Q-BPSK for a second symbol in the NGW-SIG-A. Thus, a legacy terminal and an HT terminal may recognize a legacy mode, and a VHT terminal may recognize the VHT mode. An NGW terminal may determine the NGW mode using the reserved bit.

FIGS. 7A through 7C are diagrams illustrating examples of a VHT frame detecting method according to an embodiment of the present invention.

FIGS. 7A through 7C are diagrams illustrating an NGW-SIG-A of an NGW (Type-3b) frame to provide an example of detecting a frame mode. The NGW (Type-3b) frame may be a frame format newly defining other sets of signal information, for example, signal information 1, signal information 2, signal information 3, and signal information 4, excluding positions of reserved bits. As in a case of the NGW (Type-3a) frame 610, an apparatus receiving the NGW (Type-3b) frame may classify the frame mode using a value of at least one reserved bit.

Referring to FIG. 7A, in a case of an NGW (Type-3b 1) frame 700, a frame mode 710 may be detected using a value of a first reserved bit 710 among reserved bits 710, 711, and 712. Referring to FIG. 7B, in a case of an NGW (Type-3b 2) frame 720, a frame mode 731 may be detected using a value of a second reserved bit 731 among reserved bits 730, 731, and 732. Referring to FIG. 7C, in a case of an NGW (Type-3b 3) frame 740, a frame mode 752 may be detected using a value of a third reserved bit 752 among reserved bits 750, 751, and 752.

A modulation method of the SIGs of the NGW (Type-3a) and the NGW (Type-3b) frames may be identically performed as in a VHT mode frame, and performed for an NGW device to recognize an NGW frame mode using reserved bits. An L-SIG may not be easily used to detect a frame mode because a performance of determining an occurrence of an error of a parity bit may decrease and a reserved bit may be already used for another purpose. However, an HT-SIG or a VHT-SIG may have a cyclic redundancy check (CRC) field and a highly desirable error detecting performance and thus, may be used to detect the frame mode.

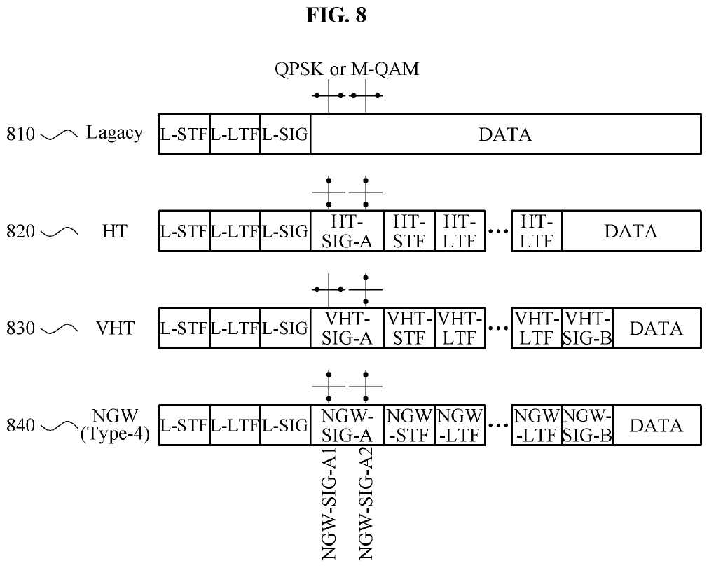

FIG. 8 is a diagram illustrating a still another example of an NGW frame transmitting method according to an embodiment of the present invention.

Referring to FIG. 8, a legacy frame 810 may be transmitted using a QPSK modulation method for a first symbol and a second symbol in an SIG. An HT frame 820 may be transmitted using a Q-BPSK modulation method for a first symbol and a second symbol in an SIG. A VHT frame 830 may be transmitted using a BPSK for a first symbol in an SIG and the Q-BPSK modulation method for a second symbol in the SIG.

An NGW (Type-4) frame 840 transmitting method may be performed using the Q-BPSK modulation method for both the two symbols same as in the HT-SIG. Thus, an HT device and a VHT device may recognize the frame as an HT frame, and a legacy device may recognize the frame as a legacy frame. An NGW device may determine whether the frame is an NGW frame using a reserved bit. For example, when the reserved bit is “0,” the frame may be recognized as the NGW frame. When the reserved bit is “1,” the frame may be recognized as the HT frame.

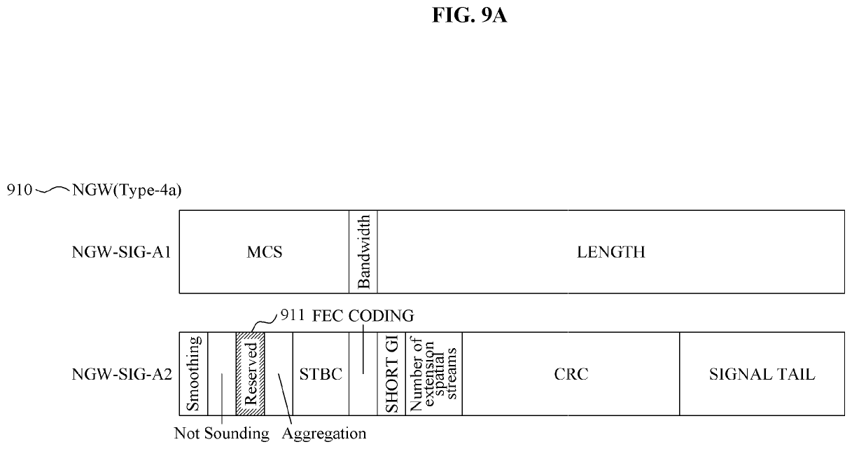

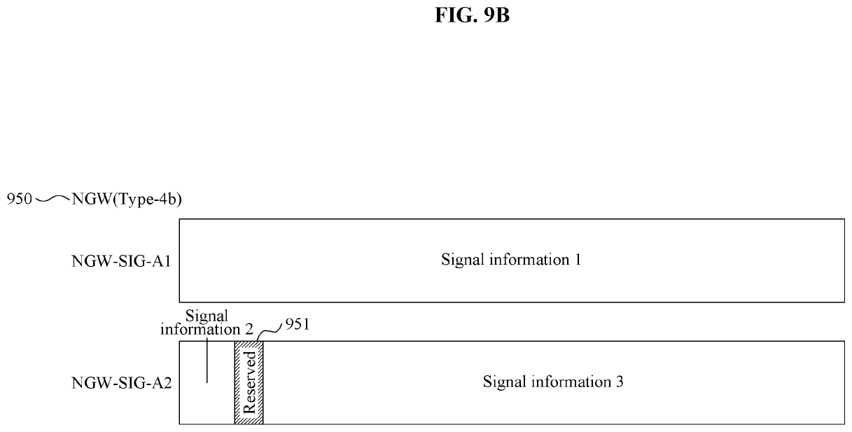

FIGS. 9A and 9B are diagrams illustrating examples of an HT frame detecting method according to an embodiment of the present invention.

Referring to FIG. 9A, an NGW (Type-4a) frame 910 transmitting method may include determining an NGW frame using a reserved bit 911. The NGW (Type-4a) frame 910 transmitting method may be performed, in a same manner as in an HT-SIG, using a Q-BPSK modulation method for both two symbols. Thus, an HT device and a VHT device may recognize the frame as an HT frame. A legacy device may recognize the frame as a legacy frame. An NGW (Type-4a) device may determine whether the frame is an NGW frame using the reserved bit 911. For example, when the reserved bit 911 is “0,” the device may recognize the frame as the NGW frame. When the reserved bit 911 is “1,” the device may recognize the frame as the HT frame.

Referring to FIG. 9B, an NGW (Type-4b) frame 950 may be a frame format newly defining other sets of signal information, for example, signal information 1, signal information 2, and signal information 3, excluding a position of a reserved bit. As illustrated in FIG. 9A, an NGW (Type-4b) frame 950 transmitting method may be performed, in a same manner as in an HT-SIG, using a Q-BPSK modulation method for both two symbols. Thus, an HT device and a VHT device may recognize the frame as an HT frame, and a legacy device may recognize the frame as a legacy frame. An NGW (Type-4b) device may determine whether the frame is an NGW frame using a reserved bit 951. For example, when the reserved bit 951 is “0,” the device may recognize the frame as the NGW frame. When the reserved bit 951 is “1,” the device may recognize the frame as the HT frame.

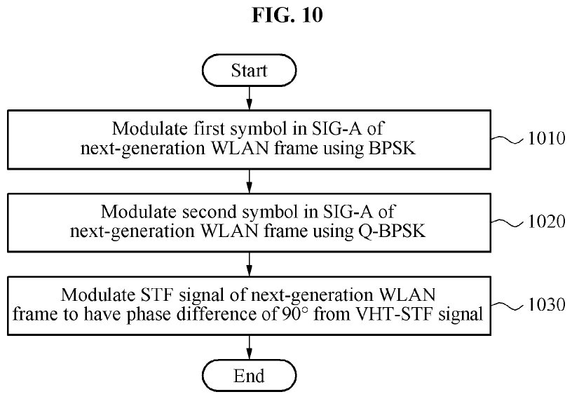

FIGS. 10 through 21 are flowcharts illustrating examples of a next-generation WLAN frame communication method according to embodiments of the present invention.

FIG. 10 is a flowchart illustrating an example of an NGW (Type-1a) frame transmitting method. A next-generation WLAN frame transmitting method may be performed using a next-generation WLAN frame communication apparatus. The next-generation WLAN frame may be transmitted by a transmitter of the next-generation WLAN frame communication apparatus, and received by a receiver of the next-generation WLAN frame communication apparatus. The foregoing description may be applicable to the following operations.

Referring to FIG. 10, in operation 1010, the transmitter modulates a first symbol in an SIG-A of the NGW frame using BPSK.

In operation 1020, the transmitter modulates a second symbol in the SIG-A of the NGW frame using Q-BPSK.

In operation 1030, the transmitter modulates an STF signal of the NGW frame to have a phase difference of 90° from a VHT-STF signal. The NGW-STF signal may be transmitted with a BPSK signal being mapped to (−1, 1) and (1, −1) coordinates, and the VHT-STF signal may be transmitted with a BPSK signal being mapped to (1, 1) and (−1, −1) coordinates. Thus, the NGW-STF signal and the VHT-STF signal may be modulated to have the phase difference of 900 therebetween.

The next-generation WLAN frame communication apparatus may recognize the frame as a VHT or an NGW frame based on the BPSK and the Q-BPSK signal in the SIG, and recognize a frame mode by recognizing a phase of the STF signal.

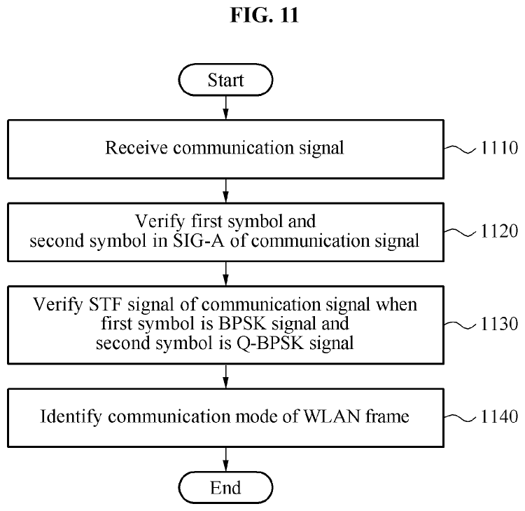

FIG. 11 is a flowchart illustrating an example of an NGW (Type-1a) frame receiving method. A next-generation WLAN frame receiving method may be performed by a next-generation WLAN frame communication apparatus.

Referring to FIG. 11, in operation 1110, a receiver of the next-generation WLAN frame communication apparatus receives a communication signal.

In operation 1120, the receiver verifies a first symbol and a second symbol in an SIG-A of the communication signal.

In operation 1130, the receiver verifies an STF signal of the communication signal when the first symbol is a BPSK signal and the second symbol is a Q-BPSK signal.

In operation 1140, the receiver identifies a communication mode of a WLAN frame based on the STF signal. When an NGW-STF signal has a phase difference of 90° from a VHT-STF signal, the receiver may determine the communication mode to be a next-generation WLAN mode. When the NGW-STF signal has no phase difference from the VHT-STF signal, the receiver may determine the communication mode to be a VHT mode.

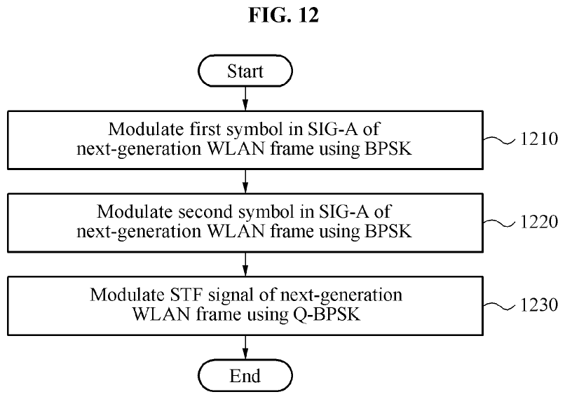

FIG. 12 is a flowchart illustrating an example of an NGW (Type-1b) frame transmitting method.

Referring to FIG. 12, in operation 1210, a transmitter modulates a first symbol in an SIG-A of an NGW frame using BPSK.

In operation 1220, the transmitter modulates a second symbol in the SIG-A of the NGW frame using the BPSK.

In operation 1230, the transmitter modulates an STF signal of the NGW frame using Q-BPSK.

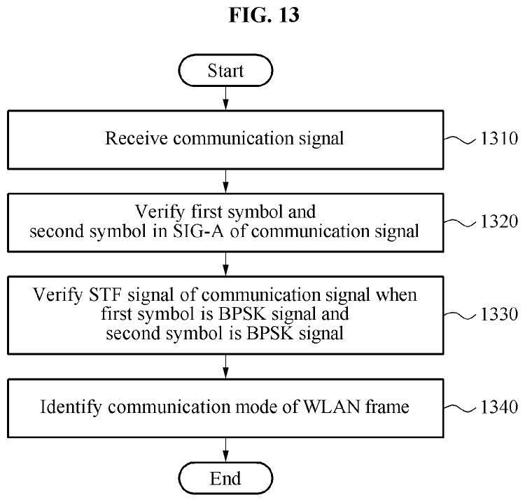

FIG. 13 is a flowchart illustrating an example of an NGW (Type-1b) frame receiving method.

Referring to FIG. 13, in operation 1310, a receiver receives a communication signal.

In operation 1320, the receiver verifies a first symbol and a second symbol in an SIG-A of the communication signal.

In operation 1330, the receiver verifies an STF signal of the communication signal when the first symbol is a BPSK signal and the second symbol is a BPSK signal.

In operation 1340, the receiver identifies a communication mode of a WLAN frame based on the STF signal. When the STF signal is a Q-BPSK signal, the receiver may identify the communication mode to be a next-generation WLAN mode. When the STF signal is a BPSK signal, the receiver may identify the communication mode to be a legacy mode.

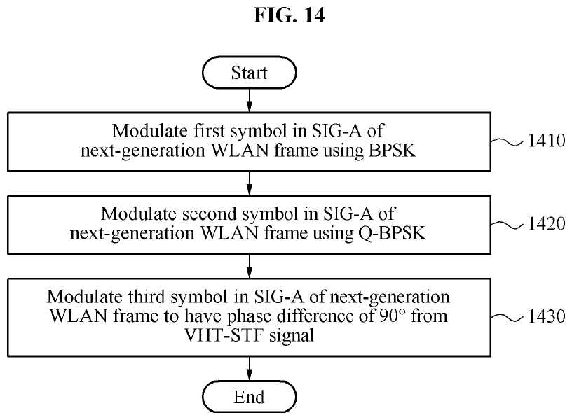

FIG. 14 is a flowchart illustrating an example of an NGW (Type-2a) frame transmitting method.

Referring to FIG. 14, in operation 1410, a transmitter modulates a first symbol in an SIG-A of an NGW frame using BPSK.

In operation 1420, the transmitter modulates a second symbol in the SIG-A of the NGW frame using Q-BPSK.

In operation 1430, the transmitter modulates a third symbol in the SIG-A of the NGW frame to have a phase difference of 90° from a VHT-STF signal. In the STF signal, a BPSK signal may be mapped to (−1, 1) and (1, −1) signal coordinates.

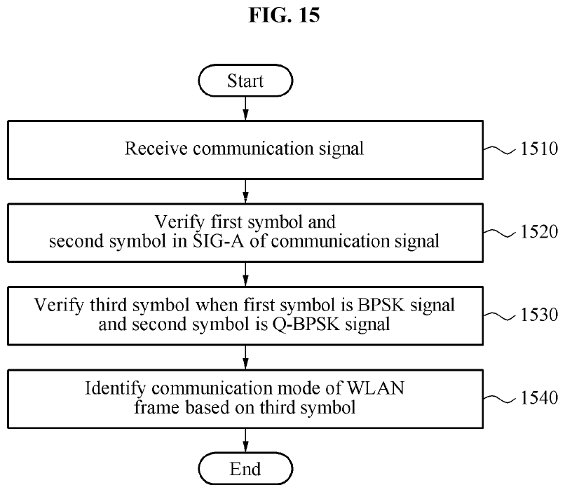

FIG. 15 is a flowchart illustrating an example of an NGW (Type-2a) frame receiving method.

Referring to FIG. 15, in operation 1510, a receiver receives a communication signal.

In operation 1520, the receiver verifies a first symbol and a second symbol in an SIG-A of the communication signal.

In operation 1530, the receiver verifies a third symbol in the SIG-A when the first symbol is a BPSK signal and the second symbol is a Q-BPSK signal.

In operation 1540, the receiver identifies a communication mode of a WLAN frame based on the third symbol. When the third symbol has a phase difference of 90° from a VHT-STF signal, the receiver may determine the communication mode to be a next-generation WLAN mode. When the third symbol has no phase difference from the VHT-STF signal, the receiver may determine the communication mode to be a VHT mode.

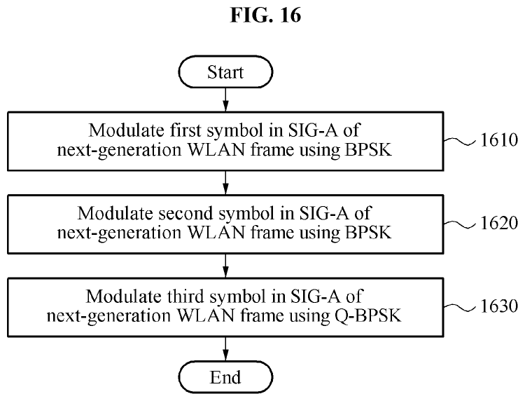

FIG. 16 is a flowchart illustrating an example of an NGW (Type-2b) frame transmitting method.

Referring to FIG. 16, in operation 1610, a transmitter modulates a first symbol in an SIG-A of an NGW frame using BPSK.

In operation 1620, the transmitter modulates a second symbol in the SIG-A of the NGW frame using the BPSK.

In operation 1630, the transmitter modulates a third symbol in the SIG-A of the NGW frame using Q-BPSK.

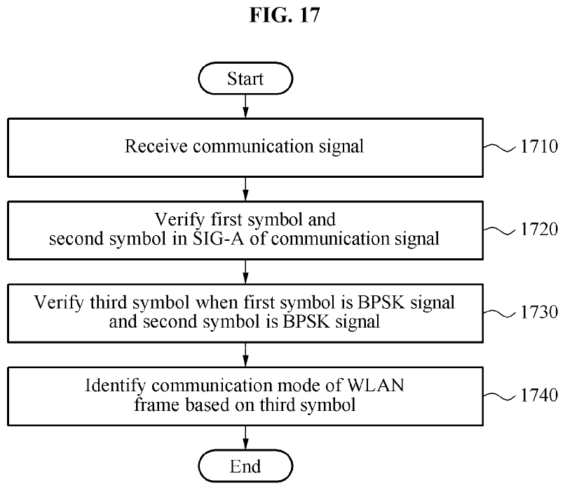

FIG. 17 is a flowchart illustrating an example of an NGW (Type-2b) frame receiving method.

Referring to FIG. 17, in operation 1710, a receiver receives a communication signal.

In operation 1720, the receiver verifies a first symbol and a second symbol in an SIG-A of the communication signal.

In operation 1730, the receiver verifies a third symbol in the SIG-A when the first symbol is a BPSK signal and the second symbol is a BPSK signal.

In operation 1740, the receiver identifies a communication mode of a WLAN frame based on the third symbol in the SIG-A. When the third symbol in the SIG-A is a Q-BPSK signal, the receiver may determine the communication mode to be a next-generation WLAN mode. When the third symbol in the SIG-A is a BPSK signal, the receiver may determine the communication mode to be a legacy mode.

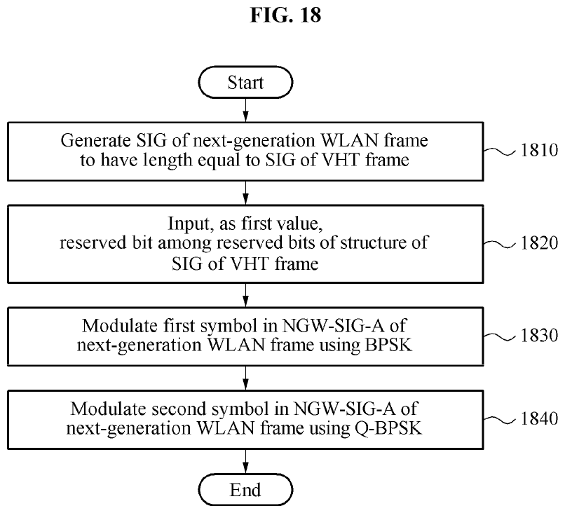

FIG. 18 is a flowchart illustrating an example of an NGW (Type-3a) frame and an NGW (Type-3b) transmitting method.

Referring to FIG. 18, in operation 1810, a transmitter generates an SIG of an NGW frame to have a length identical to an SIG of a VHT frame. Here, the transmitter may generate the SIG of the NGW frame to have a structure identical to a structure of the SIG of the VHT frame. Alternatively, the transmitter may generate the SIG of the NGW frame to have a structure different from the structure of the SIG of the VHT frame.

In operation 1820, the transmitter inputs, as a first value, a reserved bit among reserved bits in the structure of the SIG of the VHT frame. For example, the transmitter may input, as the first value, a predetermined reserved bit among the reserved bits in the structure of the SIG of the VHT frame. In a next-generation WLAN mode, the transmitter may input the predetermined reserved bit as the first value. In a VHT mode, the transmitter may input the predetermined reserved bit as a second value.

In operation 1830, the transmitter modulates a first symbol in an NGW-SIG-A of the NGW frame using BPSK. In operation 1840, the transmitter modulates a second symbol in the NGW-SIG-A of the NGW frame using Q-BPSK.

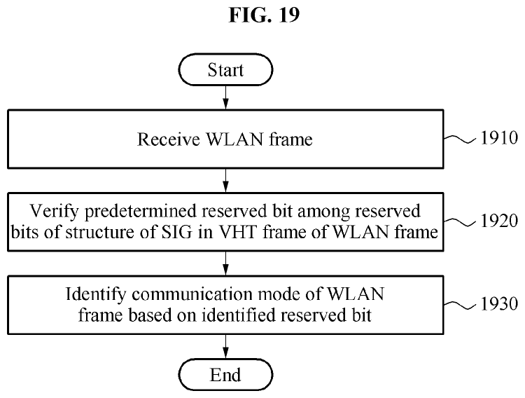

FIG. 19 is a flowchart illustrating an example of an NGW (Type-3a) frame and an NGW (Type-3b) frame receiving method.

Referring to FIG. 19, in operation 1910, a receiver receives a WLAN frame.

In operation 1920, the receiver identifies a predetermined reserved bit among reserved bits in a structure of an SIG of a VHT frame of the WLAN frame.

In operation 1930, the receiver identifies a communication mode of the WLAN frame based on the identified reserved bit. When the reserved bit is a first value, the receiver may determine the communication mode to be a next-generation WLAN mode. When the reserved bit is a second value, the receiver may determine the communication mode to be a VHT mode. For example, when the reserved bit is “0,” the receiver may determine the communication mode to be the next-generation WLAN mode. When the reserved bit is “1,” the receiver may determine the communication mode to be the VHT mode.

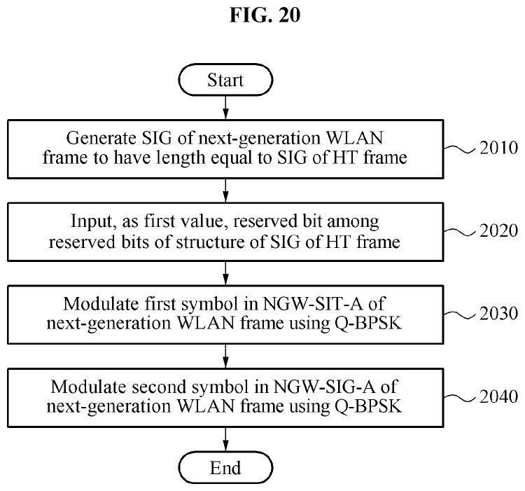

FIG. 20 is a flowchart illustrating an example of an NGW (Type-4a) frame and an NGW (Type-4b) frame transmitting method.

Referring to FIG. 20, in operation 2010, a transmitter generates an SIG of an NGW frame to have a length identical to an SIG of an HT frame. In a next-generation WLAN mode, a predetermined reserved bit may be input as a first value. In an HT mode, the predetermined reserved bit may be input as a second value. The transmitter may also generate the SIG of the NGW frame to have a structure different from a structure of the SIG of the HT frame.

In operation 2020, the transmitter inputs, as the first value, a reserved bit in the structure of the SIG of the HT frame.

In operation 2030, the transmitter modulates a first symbol in an NGW-SIG-A of the NGW frame using Q-BPSK. In operation 2040, the transmitter modulates a second symbol in the NGW-SIG-A of the NGW frame using the Q-BPSK.

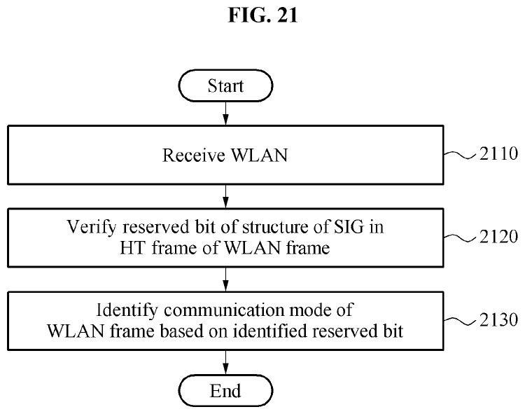

FIG. 21 is a flowchart illustrating an example of an NGW (Type-4a) frame and an NGW (Type-4b) frame receiving method.

Referring to FIG. 21, in operation 2110, a receiver receives a WLAN frame.

In operation 2120, the receiver identifies a reserved bit in a structure of an SIG of an HT frame of the WLAN frame.

In operation 2130, the receiver identifies a communication mode of the WLAN frame based on the identified reserved bit. When the reserved bit is a first value, the communication mode may be determined to be a next-generation WLAN mode. When the reserved bit is a second value, the communication mode may be determined to be an HT mode.

According to an embodiment, a next-generation WLAN frame communication apparatus may be compatible with IEEE 802.11a/n/ac, and transmit a distinguishable high-efficiency and high-performance NGW frame.

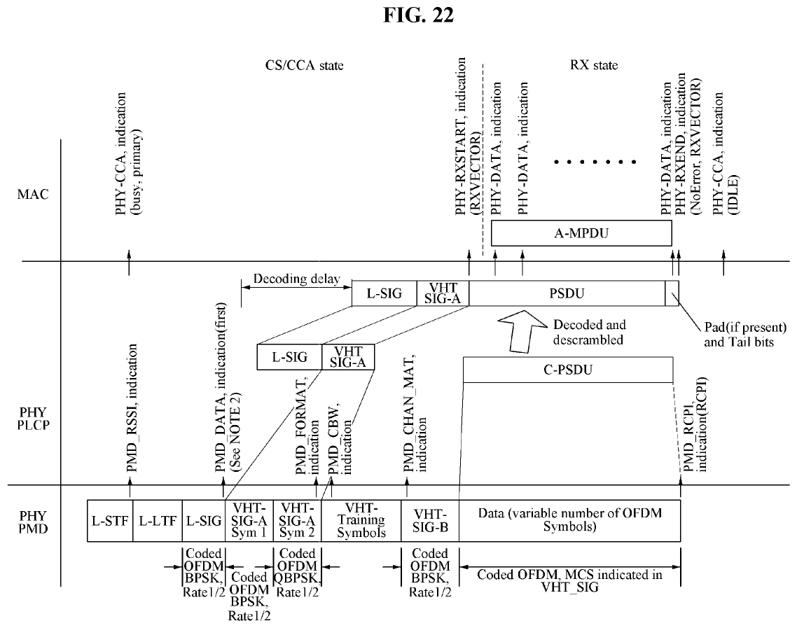

FIG. 22 is a diagram illustrating an example of a structure of an IEEE 802.11 physical layer.

Referring to FIG. 22, the structure of the IEEE 802.11 physical layer may include a physical layer management entity (PLME), a PLCP sublayer, and a physical medium dependent (PMD) sublayer. The PLME may function as an interface between an MAC layer management entity (MLME) and the physical layer, and provide a function of managing the physical layer. The PLCP sublayer may deliver an MPDU received from an MAC sublayer based on a signal generated between the MAC sublayer and the PMD sublayer by a control of an MAC layer, or deliver a frame to be received from the PMD sublayer to the MAC sublayer. The PMD sublayer, as a sublayer of a PLCP, may support the physical layer to allow two terminals to perform transmission and reception therebetween through a wireless medium. The MPDU delivered by the MAC sublayer may be referred to as a physical service data unit (PSDU) in the PLCP sublayer. Here, A-MPDU, which is an aggregation of plural MPDUs, may be transmitted.

During the delivery of the PSDU received from the MAC sublayer to be transmitted to the PMD sublayer, the PLCP sublayer may append a field including required information by a physical layer transmitter and receiver. The field to be appended may include, in the PSDU, a PLCP preamble, a PLCP header, a tail bit to initialize a state of a convolutional encoder, and the like.

The PLCP preamble may include a periodic and iterative sequence to match synchronization and control a gain for a receiver to successfully restore the PSDU, or to verify a channel state. The PLCP header may include sets of information required for restoration of the PSDU. For example, the PLCP header may include a packet length, a bandwidth, technology used for MCS and transmission, and the like. A data field may include an encoded sequence obtained as a service field including an initialization sequence for initializing a scrambler and tail bits are appended to one another. The data field may be modulated and encoded based on a transmission type included in the PLCP header and then be transmitted. The PLCP sublayer at a transmitting end may generate a PPDU and transmit the generated PPDU through the PMD sublayer. The PLCP sublayer at a receiving end may receive the PPDU, perform synchronization and gain control based on the PLCP preamble, obtain channel state information, and perform restoration by obtaining information required for packet restoration through the PLCP header.

In the IEEE 802.11ac standard, a 20 megahertz (MHz) or a 40 MHz bandwidth mode, which is supported by the IEEE 802.11n standard, may be supported, and a 80 MHz bandwidth may also be supported. In accordance with the IEEE 802.11ac standard, transmission may be performed using two non-contiguous 80 MHz simultaneously, which is referred to as non-contiguous 160 MHz bandwidth signal transmission. In addition, contiguous 160 MHz bandwidth signal transmission may also be possible. An AP supporting the IEEE 802.11ac standard may transmit a packet to at least one terminal simultaneously using MU-MIMO transmission technology. In a basic service set of a WLAN, the AP may simultaneously transmit data, which is classified into different spatial streams, to groups including at least one terminal among a plurality of terminals associated with the AP. In addition, the AP may also transmit the data to one terminal using a signal-user MIMO (SU-MINO) method. When beamforming technology is supported between the AP and a terminal belonging to a network, transmission to a single terminal or a terminal group may be performed to increase a signal gain. A group ID may be allocated to a terminal group to support MU-MINO transmission. The AP may allocate and distribute the group ID by transmitting a group ID management frame. A terminal may receive a plurality of group IDs. A WLAN terminal or the AP may support different functions depending on a vendor who implements a system and produces a chip. In the standard, optional items to be implemented may be stipulated in addition to mandatory items. Functions to be supported may be different depending on an implemented version of a standard. For example, although convolutional encoding technology is one of the mandatory items, low density parity check (LDPC) technology may be an optional item to be implemented. In addition, beamforming, MU-MIMO, and 160 MHz bandwidth support may also be optional items.

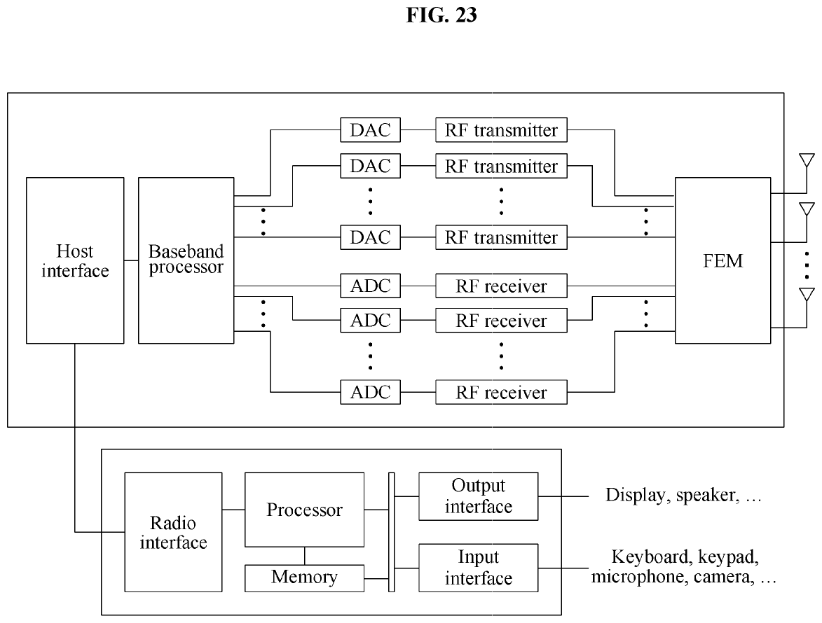

FIG. 23 is a diagram illustrating an example of a configuration of a next-generation WLAN frame communication system according to an embodiment of the present invention.

Referring to FIG. 23, a wireless communication apparatus includes a transmitting and receiving antenna, a front end module (FEM), a transmitter, a receiver, an analog-to-digital converter (ADC), a digital-to-analog converter (DAC), a baseband processor, a host interface, a radio interface, a processor, a memory, and input and output interfaces. A signal may be transmitted and received through at least one antenna. The FEM may interface the transmitting and receiving antenna with an RF transmitter and receiver. The FEM may include various external devices that are not included in the RF transmitter and receiver and devices to improve performances and functions. For example, the FEM may include an external transmission power amplifier or an external reception low-noise amplifier, a switch, and the like. The transmitter may modulate a packet to be transmitted and transmit the modulated packet, and the receiver may demodulate the received packet. The ADC and the DAC may perform conversion between an analog signal and a digital signal to convert a form of the signals. The baseband processor may generate a frame based on a transmission frame format, extract information from a received frame, perform encoding and decoding, or compensate for a signal distorted by a channel or an analog device. The radio interface may function as an interface between a wireless communication modem and a host. The processor may generate a PPDU format and be set to transmit the generated PPDU format. In addition, the processor may be set to receive the transmitted PPDU, and obtain control information by interpreting field information based on a received packet to restore data. The processor or a transceiver may include an application specific integrated circuit (ASIC), a logic circuit, or a data processing device. The memory may include a read only memory (ROM), a read access memory (RAM), a flash memory, a memory card, and a storage device. The input interface may be, for example, a keyboard, a keypad, a microphone, a camera, and the like. The output interface may be, for example, a display, a speaker, and the like. When example embodiments described herein are implemented as software or hardware, processes through which functions described herein are performed and the functions may be implemented as modules. Such modules may be provided in a form of a chip, a logic circuit, a data processing device, or a processor, and implemented in such a form.

What is claimed is:

1. A method performed by a wireless communication device for transmitting physical layer protocol data unit (PPDU) in wireless local area network (WLAN), the method comprising:
transmitting a first symbol;
transmitting a second symbol following the first symbol;
transmitting a third symbol following the second symbol; and
transmitting a fourth symbol following the third symbol;
wherein the first symbol, the second symbol, and the third symbol are modulated using an identical modulation method; and
wherein a version of the PPDU is defined using a modulation method of the first symbol, a modulation method of the fourth symbol, and at least one bit value included in the third symbol.

2. The method of claim 1, wherein the first symbol is modulated using binary phase-shift keying (BPSK) scheme.

3. The method of claim 1, wherein the first symbol corresponds to Legacy-Signal (L-SIG) field.

4. The method of claim 1, wherein the PPDU includes a Legacy-Short Training (Legacy-Short Training) filed, and a Legacy-Long Training (L-LTF) field before the first symbol.

5. A wireless communication device for transmitting physical layer protocol data unit (PPDU) in wireless local area network (WLAN), the wireless communication device comprising:
at least one transceiver;
at least one processor operably connected to the at least one transceiver, wherein the at least one processor is configured to:
transmit a first symbol;
transmit a second symbol following the first symbol;
transmit a third symbol following the second symbol; and
transmit a fourth symbol following the third symbol;
wherein the first symbol, the second symbol, and the third symbol are modulated using an identical modulation method; and
wherein a version of the PPDU is defined using a modulation method of the first symbol, a modulation method of the fourth symbol, and at least one bit value included in the third symbol.

6. The wireless communication device of claim 5, wherein the first symbol is modulated using binary phase-shift keying (BPSK) scheme.

7. The wireless communication device of claim 5, wherein the first symbol corresponds to Legacy-Signal (L-SIG) field.

8. The wireless communication device of claim 5, wherein the PPDU includes a Legacy-Short Training (Legacy-Short Training) filed, and a Legacy-Long Training (L-LTF) field before the first symbol.
